(19) United States
(12) Patent Application Publication
(10) Pub. No.: US 2024/0344891 A1
(43) Pub. Date: Oct. 17, 2024

(54) Integrated High-Extinction Ratio Unbalanced Mach Zehnder Interferometers and Integrated Mach Zehnder Interferometers Incroporating Coil Resonators

(71) Applicant: The Regents of the University of California, Oakland, CA (US)

(72) Inventors: Kaikai Liu, Santa Barbara, CA (US); Jiawei Wang, Goleta, CA (US); Andrei Isichenko, Goleta, CA (US); Nitesh Chauhan, Goleta, CA (US); Daniel J. Blumenthal, Santa Barbara, CA (US)

(73) Assignee: The Regents of the University of California, Oakland, CA (US)

(21) Appl. No.: 18/393,142

(22) Filed: Dec. 21, 2023

Related U.S. Application Data
(60) Provisional application No. 63/476,586, filed on Dec. 21, 2022.

(51) Int. Cl. G01J 9/02; G02F 1/21; G02F 1/225

(52) U.S. Cl. CPC G01J 9/02; G02F 1/212; G02F 1/225; G01J 2009/023; G01J 2009/0288; G02F 2203/15

(57) ABSTRACT

A device may include a first waveguide with an optical input at a first port. A device may include a second waveguide. A device may include a first coupler that optically couples the first waveguide to the second waveguide at a first position. A device may include a waveguide delay arm. A device may include a second coupler that optically couples the first waveguide to the second waveguide at a second position, the second position different from the first position.

### CROSS REFERENCE TO RELATED APPLICATIONS

The current application claims the benefit of and priority under 35 U.S.C. § 119 (e) to U.S. Provisional Patent Application No. 63/476,586 entitled “Integrated High-Extinction Ratio Unbalanced Mach Zehnder Interferometers for Laser Frequency Noise Measurements” filed Dec. 21, 2022, the disclosure of which is incorporated herein by reference in its entirety for all purposes.

### STATEMENT OF FEDERAL SUPPORT

This invention was made with government support under HR0011-22-2-0008 awarded by the Defense Advanced Research Projects Agency. The government has certain rights in the invention.

### FIELD OF THE INVENTION

The present invention generally relates to photonic integrated circuits incorporating Mach Zehnder interferometers. In particular it relates to photonic integrated circuits incorporating Mach Zehnder interferometers that incorporate delay arms and/or coil resonators.

### BACKGROUND

Optical frequency noise is a central parameter in the performance of many precision applications in modern precision science and technology, such as optical gyroscopes, optical atomic clocks, and/or gravitational wave detection, quantum sensors and computing, as well as modern optical communications and/or other optical systems, where accurate and sensitive measurement of optical frequency and phase is essential to the application performance beyond that determined by a simple linewidth value. Additionally, operation of these systems depends on the optical frequency noise offset from the carrier at specific frequencies or over defined frequency bands. Examples of devices that require careful characterization of frequency noise are ultra-low-noise stabilized lasers. Many precision applications and other applications specify the required optical frequency noise at key offset frequencies. Performance of these application can be optimized by controlling parameters according to specific frequency noise measurements.

Systems to measure optical frequency noise are critical to characterizing devices and systems and establishing desired operating conditions in precision optical applications. The unbalanced fiber optical delay line Mach Zehnder interferometers (MZI) is commonly used as optical frequency discriminators (OFD) in delayed self-homodyne or self-heterodyne laser noise measurements with balanced photo-detection and correlated heterodyne techniques for an improved noise floor. Legacy solution for Mach-Zehnder interferometers used as optical frequency discriminators include bulk optic solutions.

### SUMMARY OF THE INVENTION

In some embodiments, the techniques described herein relate to a photonic integrated circuit forming part of a Mach Zehnder interferometer. In an embodiment, the photonic integrated circuit including: a first waveguide with an optical input at a first port and including a waveguide delay arm; a second waveguide; a first coupler that optically couples the first waveguide to the second waveguide at a first position; and a second coupler that optically couples the first waveguide to the second waveguide at a second position, the second position different from the first position.

In another embodiment, the light received to the first port sequentially passes first through the first coupler, second through the waveguide delay arm, and third through the second coupler.

In yet another embodiment, the waveguide delay arm is around 2 meters long.

In still another embodiment, the waveguide delay arm is positioned between the first coupler and the second coupler along a beamline.

In another additional embodiment, a first output port of the first waveguide and a second output port of the second waveguide is connected to a photodetector such that an optical signal can be used for optical frequency discrimination.

In yet still another embodiment again, a first output port of the first waveguide and a second output port of the second waveguide is connected to a detector such that an optical signal can be used to generate a control input for a laser.

In yet another embodiment again, the first coupler has a gap of around 2 μm and a length of around 1.4 mm.

In still another embodiment again, a first output port of the first waveguide and a second output port of the second waveguide are used for laser stabilization.

In another additional embodiment again, a laser optical frequency is selected from a list consisting of Deep UV, UV, near UV, Visible, Near IR, Mid IR and IR wavelengths.

In yet still another embodiment again, the photonic integrated circuit is formed of a material, the material selected from a list consisting of silicon nitride, tantalum pentoxide, alumina nitride, and alumina oxide.

In several embodiments, the techniques described herein relate to a photonic integrated circuit forming part of a Mach Zehnder interferometer. In an embodiment, the photonic integrated circuit including: a resonator; a first waveguide including an optical input at a first port and a delay arm; a second waveguide, the second waveguide coupled to the resonator at a first position; a first coupler that optically couples the first waveguide to the second waveguide at a second position; and a second coupler that optically couples the first waveguide to the second waveguide at a third position; wherein the waveguide delay arm is positioned between the first coupler and the second coupler.

In a further embodiment, the optical properties of the delay arm can be configured by a tuning effect, the tuning effect selected from a list consisting of electro-optic tuning effect, stress-optic tuning effect, current-injection tuning effect, and thermo-optic tuning effect.

In a yet further embodiment, the waveguide resonator is a coil resonator.

In a still further embodiment, an output from an output port is connected to a photodetector such that an optical signal can be used for optical frequency discrimination.

In a further additional embodiment, an output from an output port is connected to a detector such that an optical signal can be used to generate a control input for a feedback loop to lock a laser.

In a yet still further embodiment, the first coupler has a gap of around 1 μm and a length of around 1.4 mm.

In a further embodiment again, a first output port of the first waveguide and a second output port of the second waveguide are used for laser stabilization.

In a yet further embodiment again, a laser optical frequency is selected from a list consisting of Deep UV, UV, near UV, Visible, Near IR, Mid IR and IR wavelengths.

In a still further embodiment again, the photonic integrated circuit is formed of a material, the material selected from a list consisting of silicon nitride, tantalum pentoxide, alumina nitride, and alumina oxide.

In many embodiments, the techniques described herein relate to a photonic integrated circuit forming part of a Mach Zehnder interferometer. In an embodiment, the photonic integrated circuit including: a first waveguide with an optical input at a first port and a delay arm; a second waveguide; a first coupler that optically couples the first waveguide to the second waveguide at a first position; a waveguide coil resonator; and a second coupler that optically couples the first waveguide to the second waveguide at a second position, the second position different from the first position.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 conceptually illustrates an example Mach Zehnder interferometer (MZI) photonic integrated circuit with a long delay arm.

FIGS. 2A through 2E depict example data obtained from an example Mach Zehnder interferometer photonic integrated circuit with a long delay arm.

FIG. 3 conceptually illustrates an example integrated high-extinction ratio unbalanced Mach Zehnder interferometer.

FIG. 4 conceptually illustrates an example integrated self-delayed coil-resonator for high sensitivity optical frequency discrimination.

FIG. 5 conceptually illustrates an example integrated self-delayed coil-resonator for laser linewidth narrowing.

FIGS. 6A through 6B conceptually illustrate example data obtained from an example MZI with integrated self-delayed coil-resonator.

FIGS. 7A through 7B conceptually illustrate example laser noise measurements and laser stabilization data, the data suitable for comparing modulation-free cavity OFD to fiber uMZI OFD.

FIG. 8 conceptually illustrates an example self-delayed coil resonator suitable for use in OFD and laser stabilization.

### DETAILED DESCRIPTION

Optical frequency noise is a central parameter in the performance of many precision applications in modern precision science and technology, such as optical gyroscopes, optical atomic clocks, and/or gravitational wave detection, quantum sensors and computing, as well as modern optical communications and/or other optical systems, where accurate and sensitive measurement of optical frequency and phase is essential to the application performance beyond that determined by a simple linewidth value. Additionally, operation of these systems depends on the optical frequency noise offset from the carrier at specific frequencies or over defined frequency bands. Examples of devices that require careful characterization of frequency noise are ultra-low-noise stabilized lasers. Many precision applications and other applications specify the required optical frequency noise at key offset frequencies. Performance of these application can be optimized by controlling parameters according to specific frequency noise measurements.

An example of an optical system that is characterized by frequency noise is the ultra-low noise stabilized laser. Ultra-low-noise stable lasers can enable a wide range of applications in modern precision science and technology, such as optical gyroscopes, optical atomic clocks, and/or gravitational wave detection, as well as modern optical communications and/or other optical systems, where accurate and sensitive measurement of optical frequency and phase is essential to the application performance beyond that determined by a simple linewidth value. Unbalanced fiber optical delay line Mach Zehnder interferometers (MZI) are commonly used as optical frequency discriminators (OFD) in delayed self-homodyne or self-heterodyne laser noise measurements with balanced photo-detection and correlated heterodyne techniques for an improved noise floor. However, fiber-optic MZI-OFDs can be sensitive to environmental disturbances and noise measurements below 1 kHz are typically dominated by the fiber noise. This can make heterodyne beatnote detection with a reference laser necessary for close to carrier noise. Additionally, delay length and loss can be important parameters for frequency discrimination sensitivity, dynamic range, and/or extinction ratio (ER). Improved stability, reduced size, and/or reduced cost can be achieved with photonic integration and/or in-situ monitoring.

Often, in legacy systems noise measurements are made using optical frequency discriminator (OFD) fiber-optic delay-line interferometers and laser stabilization can be achieved by locking the laser to a table-top ultra-stable optical reference cavity used as an OFD. These techniques require the OFD to deliver a high frequency discrimination sensitivity and a low noise floor while the frequency discrimination properties are combined with Pound-Drever-Hall (PDH) feedback to narrow the integral linewidth.

A wide range of applications in modern precision science and technology (e.g., quantum sensing and computing, optical gyroscopes, optical atomic clocks, gravitational wave detection, precision metrology, and optical communications) require accurate and sensitive measurement of optical frequency, accurate and sensitive measurement of phase noise and stability, where the application performance can be determined by the simple linewidth value. Other applications, including high capacity fiber optic communications, can also be enabled by such measurement techniques in several embodiments.

Unbalanced fiber optical delay line Mach Zehnder interferometers (MZI) can be used as optical frequency discriminators (OFD) to make laser frequency/phase noise measurements. However, fiber-optic MZI-OFDs are often large, space consuming, expensive, sensitive to environmental disturbances, and sensitive to noise measurements. For MZI-OFDs, the delay length and loss of the unbalanced interferometer arm can be important parameters.

Fiber unbalanced Mach Zehnder interferometers (uMZI) with a long fiber delay line and balanced photo-detection can be used for noise measurements. Additionally, PDH laser stabilization can require sideband modulation and LO demodulation to avoid photodetector DC noise and the AM-FM noise conversion, which results in unwanted residual amplitude noise.

### Integrated High-Extinction Ratio Unbalanced Mach Zehnder Interferometers for Laser Frequency Noise Measurements

In accordance with embodiments of the invention, a waveguide integrated MZI-OFD with an asymmetric delay arm can be fabricated in an ultra-low loss integration platform (e.g., a silicon nitride platform). The benefits of an ultra-low loss integration platform can include maintaining the desirable properties of the MZI (e.g., extinction ratio) as the length of the arm is modified over a wide range of lengths. An ultra-low loss waveguide integrated MZI-OFD can realize on-chip laser frequency and/or phase noise measurements and/or on-chip laser frequency noise reduction with feedback loops in many embodiments. This system can be used for photonic integration of low-noise optical components and/or their performance monitoring systems, in-situ laser performance monitoring, and/or reduction in size, weight and/or cost of such measurement techniques. A waveguide integrated MZI-OFD with an asymmetric delay arm can be fabricated in an ultra-low loss integration platform can be an integrated frequency noise measurement device.

Integration of frequency noise measurement devices into photonic integrated circuits can reduce the power, cost, size, and weight of the frequency noise measurement devices. In various embodiments integration of frequency noise measurement devices can improve the manufacturability of such devices and improve their suitability for use in commercial applications for mobile, space based, and/or higher volume applications. Integrated frequency noise measurement devices can be used in new applications, including quantum, to establish a target optical frequency noise in a system that can be used to measure and set using feedback loops or other technique. Such integrated frequency noise measurement devices can also provide benefits from integration and new opportunities in quantum, atom and/or other application spaces.

In accordance with embodiments of the invention, frequency noise measurement devices can be integrated with lasers and/or photonic integrated circuits. Some embodiments include an around 2.0-meter-long ultra-low loss Si₃N₄ waveguide unbalanced MZI with an around 96.6 MHz FSR and a around 37.5 dB extinction ratio (ER). In various embodiments, frequency noise measurement devices can perform self-delayed homodyne laser frequency noise measurements.

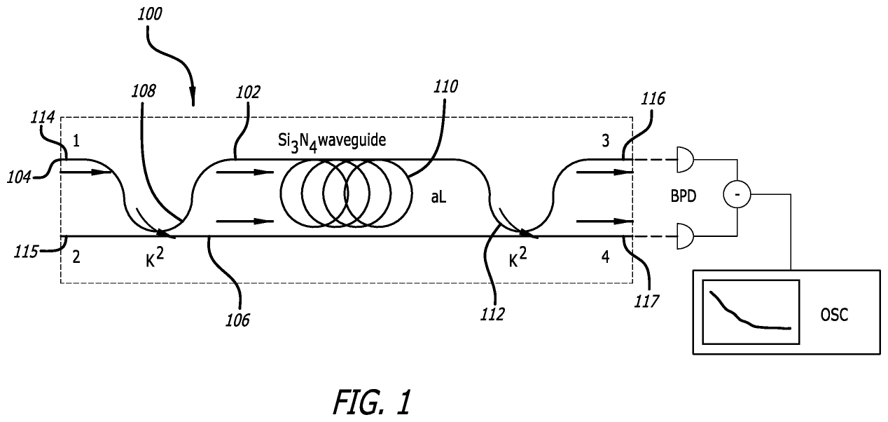

Some embodiments can include MZI photonic integrated circuits (PIC). An example MZI PIC is conceptually illustrated in FIG. 1. An MZI PIC 100 can include a waveguide 102 (e.g., an optical waveguide). The waveguide 102 can be connected to an optical input 104 (e.g., a laser). The waveguide 102 can be coupled to a second waveguide 106 by a coupler (e.g., an optical waveguide splitter) 108. In several embodiments, an optical waveguide splitter can provide nominally 50% of the light to an upper arm and nominally 50% of the light to a lower arm. The first waveguide 102 can correspond to an upper arm. The second waveguide 106 can correspond to a lower arm. The first waveguide 102 can include a waveguide delay 110. Waveguide and or arms including waveguide delays (e.g., the first waveguide 102) can be referred to as delay arms. The waveguide 102 can include a second coupler 112 after the waveguide delay 110. The second coupler can be an optical waveguide splitter the can nominally provide 50% of the light to each of the coupled waveguides. The first waveguide 102 can have a first port 114 and a third port 116. The second waveguide 106 can have a second port 115 and a fourth port 117. A photodetector 118 can be coupled to the third and fourth ports 116, 117, allowing measurements suitable for OFD. The MZI PIC 100 can be suitable for the outputs of the third and fourth ports 116, 117 to be used for stabilizing a laser. In accordance with embodiments of the invention, a waveguide delay can be a waveguide ring, a waveguide spiral, a waveguide serpentine and/or another structure that can be used to incorporate a waveguide delay arm onto a chip. In several embodiments, the delay can be lengthened by using stacked optical waveguide chips. Stacked optical waveguide chips can connect light in a first waveguide arm on a first chip to a second waveguide are on a second chip. Stacked optical waveguide chips can allow sharing light between chips, use an off-chip fiber delay line, and/or any combination of delay techniques. In several of the following plots, S₁₃ can refer to a beamline from the first port 114 to the third port 116 and S₂₄ can refer to a beamline from the second port 115 to the fourth port 117.

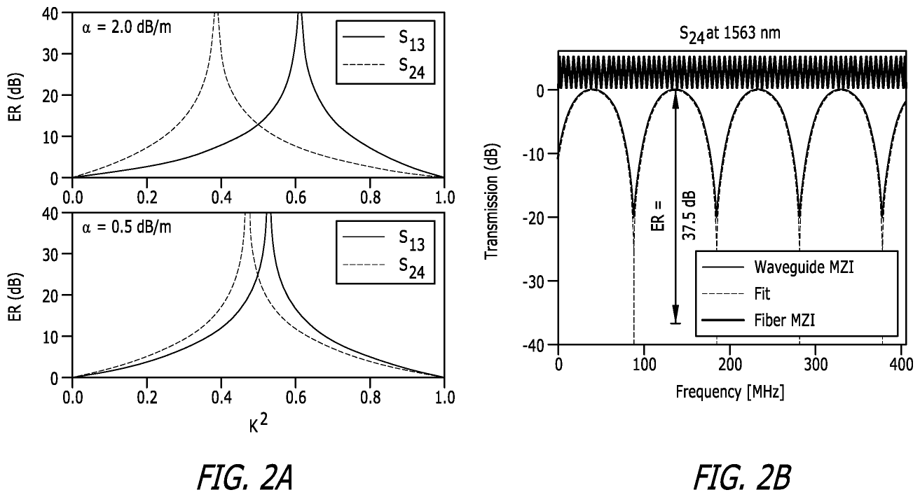

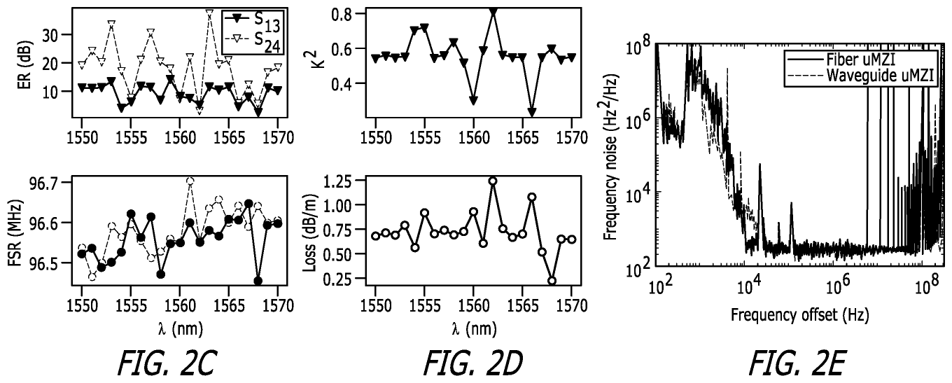

Two plots of ER versus directional coupler's coupling coefficient κ² with different propagation losses for a delay length L=2.0 m are depicted in FIG. 2A. A plot of frequency sweep of the MZI though S₂₄ at 1563 nm that shows a 37.5 dB ER is depicted in FIG. 2C.

In several embodiments, a waveguide integrated MZI-OFD can have a 2.0-meter-long delay arm, a 96.6 MHz free spectral range (FSR), a 37.5 dB extinction ratio (ER), and/or a 20 mm by 6 mm footprint. Integrated MZI-OFDs can be used to perform laser frequency measurements of a free-running external cavity laser with performance around that of a fiber MZI-OFD measurement. Many embodiments can perform on-chip laser frequency, phase noise measurements and/or on-chip laser frequency noise reduction with feedback loops. Numerous embodiments can include photonic integration of low-noise optical components and/or their performance monitoring systems such as those discussed herein.

A low noise floor in MZI-OFDs, can be improved, in several embodiments, with a lengthened delay arm length (L) and/or with a reduced propagation loss (a). In accordance with numerous embodiments of the invention, the free spectral range (FSR) can be lowered to below 100 MHz and/or measurements can have a high signal-to-noise ratio (SNR). Some embodiments can include a 200-meter-long fiber MZI-OFD. An MZI-OFD (e.g., a 200-meter MZI-OFD) can have a 1 MHz FSR with very low optical loss.

In accordance with embodiments of the invention, a small foot-print waveguide MZI for a low-noise-floor OFD can include small bending radii and low waveguide loss for the long delay arm. Higher waveguide confinement can result in a smaller bending radius without introducing bending loss and thus permitting a longer delay arm (L). Higher waveguide confinement can, in some embodiments, increase waveguide scattering loss (α). An MZI FSR can be expressed as V_{FSR}=c/n_{g}L and a corresponding S-matrix can be expressed as follows:

$$U = [ \begin{matrix}{τ}^{2} - {κ}^{2} A {e}^{i θ} & i κ τ ( 1 + A {e}^{i θ} ) \\ i κ τ ( 1 + A {e}^{i θ} & {τ}^{2} A {e}^{i θ} - {κ}^{2}\end{matrix} ] ,$$

$${S}_{13} = {\vert {U}_{11} \vert}^{2} , {S}_{24} = {\vert {U}_{22} \vert}^{2} ,$$

where A²=e^{-aL} is the delay arm attenuation and κ² (κ²+τ²=1) is the power coupling of the MZI coupler. From the S matrix, the ER as defined by the transmission maximum divided its minimum can be calculated for S₁₃ and S₂₄ for different values of κ² and A² for L=2.0 m (an example of which is depicted in FIG. 2A). demonstrating that to achieve ER above 20 dB for both S₁₃ and S₂₄ a coupling coefficient around 0.5 and loss below 0.5 dB/m can be required. In various embodiments, a coupling coefficient can be around 0.5 and/or a loss can be below around 0.5 dB/m. In several embodiments, a waveguide MZI can have a loss below 0.5 dB/m. A waveguide MZI can include an Si₃N₄ waveguide, and can be around 6 μm wide and around 80 nm thick. In accordance with several embodiments of the invention, an MZI waveguide can have a κ² around 0.5. Many embodiments include directional couplers with around 2 μm gap and/or around 1.4 mm coupling length.

Numerous embodiments can include a widely tunable laser (e.g., Velocity™ TLB-6700) to probe a waveguide MZI. A laser can sweep the frequency response of both S₁₃ and S₂₄ with a fiber MZI whose FSR is calibrated to be around 5.87 MHZ (e.g., with the corresponding delay length around 34 meters). An example frequency sweep of S₂₄ at 1563 nm with the max ER of 37.5 dB is depicted in FIG. 2B. Based on a frequency sweep an ER can be determined. FIG. 2A depicts an example, the example showing S₁₃ has an average ER of around 10 dB and S₂₄ has an average ER of around 20 dB.

A plot of example measurements of ER and FSR of an MZI from 1550 nm to 1570 nm is illustrated in FIG. 2C. Plots of example extracted κ² and a values from the ER of S₁₃ and S₂₄ are illustrated in FIG. 2D. Plots of example MZI-OFD laser noise measurements using both fiber MZI and waveguide MZI showing almost identical noise traces are illustrated in FIG. 2E.

In accordance with various embodiments, using an S-matrix model (e.g., as described elsewhere herein), a κ² and/or A² can be determined based on an ER (e.g., an ER of S₁₃ and/or S₂₄) An example plot based on this determination is illustrated FIG. 2D. In some embodiments, a waveguide MZI can yield a mean value of around 0.55 for κ² and/or around 0.73 dB/m for a.

In accordance with numerous embodiments of the invention, a waveguide MZI can be used as an OFD. A tunable laser's frequency noise can be measured with a photodetector (e.g., Thorlabs™ PDB470C photodetector). Non-balanced detection can be used when only one MZI output port is coupled to a fiber. In some embodiments, a comparison with a waveguide MZI can be based on a fiber MZI (e.g., a fiber MZI 5.87 MHz FSR) for the same measurements with balanced detection. An example of such a comparison is shown in FIG. 2E. In various embodiments, the comparison described above results in almost identical noise measurements. Waveguide MZIs in accordance with many embodiments can have a performance around equivalent to a fiber MZI 5.87 MHz FSR. In several embodiment, a waveguide MZI OFD can have discrimination slopes with a 1 V peak-to-peak voltage around 65 mV/MHz. As a comparison, a fiber MZI can discrimination slopes with a 1 V peak-to-peak voltage around 1070 mV/MHz.

In many embodiments, a waveguide integrated MZI can have an around 2.0-meter-long delay arm, an around 96.6 MHz FSR, up to around 37.5 dB ER, and/or a footprint of around 20 mm by around 6 mm. Some embodiments of a waveguide integrated MZI can provide an around identical noise trace to a fiber MZI-OFD measurement.

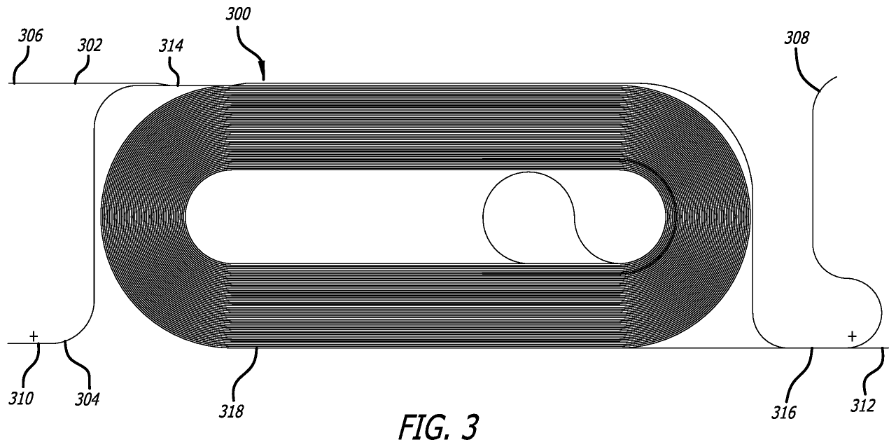

An example integrated high-extinction ratio unbalanced Mach Zehnder interferometer is conceptually illustrated in FIG. 3. An unbalanced Mach Zehnder interferometer 300 can include a first waveguide 302 and a second waveguide 304. The first waveguide 302 can have a first port 306 and a second port 308. The second waveguide 304 can have a third port 310 and a fourth port 312. The first waveguide 302 can be coupled to the second waveguide 304 by a first coupler 314. The second waveguide 304 can incorporate a delay structure 318. In many embodiments, the delay structure can be around 2 meters long and/or can have an FSR of around 99.3 MHz. The delay structure 318 can be positioned between the first coupler 314 and the second coupler 316. The second coupler can couple the first waveguide 302 to the second waveguide 304. In many embodiments the couplers can have a length around 1.4 mm and/or a gap spacing of around 2.0 μm. In accordance with many embodiments, couplers can be formed by two waveguides positioned close together. In many embodiments, waveguides can have dimensions of around 6 μm by 80 nm. Couplers, in accordance with many embodiments, can be TE mode MZI directional couplers. Couplers can have around κ²=0.48. The unbalanced Mach Zehnder interferometer described in connection with FIG. 3 can be suitable for OFD applications and/or laser stabilization and linewidth narrowing applications. In accordance with embodiments of the invention, light can be received into a first port. The light received to the first port can be coupled from a first waveguide to a second waveguide. After coupling, the light can pass through the delay arm before entering the second coupler. In accordance with many embodiments light can sequentially travel first through a first coupler, second through a delay arm, a third through a second coupler.

In many embodiments, a first output port of the first waveguide and a second output port of the second waveguide can be connected to a photodetector such that an optical signal can be used for optical frequency discrimination, laser stabilization and/or laser linewidth narrowing.

While specific methods and/or systems for integrated unbalanced Mach Zehnder interferometers are described above, any of a variety of methods and/or systems can be utilized as an integrated unbalanced Mach Zehnder interferometer as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference to an integrated unbalanced Mach Zehnder interferometer, the techniques disclosed herein may be used in any type of integrated optical system. The techniques disclosed herein may be used within any of the integrated optical systems, laser stabilization systems, linewidth narrowing systems, optical frequency discriminator systems, and/or other components and/or systems as described herein.

### Integrated Self-Delayed Coil-Resonator for High Sensitivity Optical Frequency Discrimination and Laser Linewidth Narrowing

In accordance with embodiments of the invention, an integrated self-delayed 2.0 m coil resonator can have a 61 million intrinsic Q for high-sensitivity optical frequency discrimination and/or can have semiconductor laser stabilization with 4 orders magnitude frequency noise reduction and/or 212 Hz integral linewidth.

Photonic integrated circuits are desirable to reduce the size, weight, and cost, and to achieve reduced environmental noise sensitivity for stabilized lasers and noise measurement. Approaches that deliver high-sensitivity OFD and PDH-error-like response without modulation/demodulation and residual amplitude noise are important approaches. A bulk-optic approach utilizes interference of an optical cavity response and delayed laser light with balanced photo-detection to realize frequency discrimination without sideband modulation and demodulation and has also been demonstrated using an integrated programmable photonic circuit.

Several embodiments include an integrated high-sensitivity, low-noise optical frequency discriminator (OFD) that also serves as a reference cavity for laser linewidth narrowing. Such an OFD based on a self-delayed 2.0 m coil resonator fabricated in an ultra-low-loss Si₃N₄ platform. Self-delayed coil resonators can have an around 61 million intrinsic Q, around a 96.9 MHZ FSR, and/or frequency noise discrimination sensitivity of around 0.51 V/MHz. Using such a cavity, some embodiments can achieve over 4 orders of magnitude frequency noise reduction of a free running semiconduction laser and 212 Hz integral linewidth representing an around 17× integral linewidth reduction over the free running laser. Several embodiments using such an approach offer the advantage of a PDH-error-signal-like response with high-sensitivity and AM-to-FM-conversion-free frequency discrimination without modulation and the resulting residual amplitude noise.

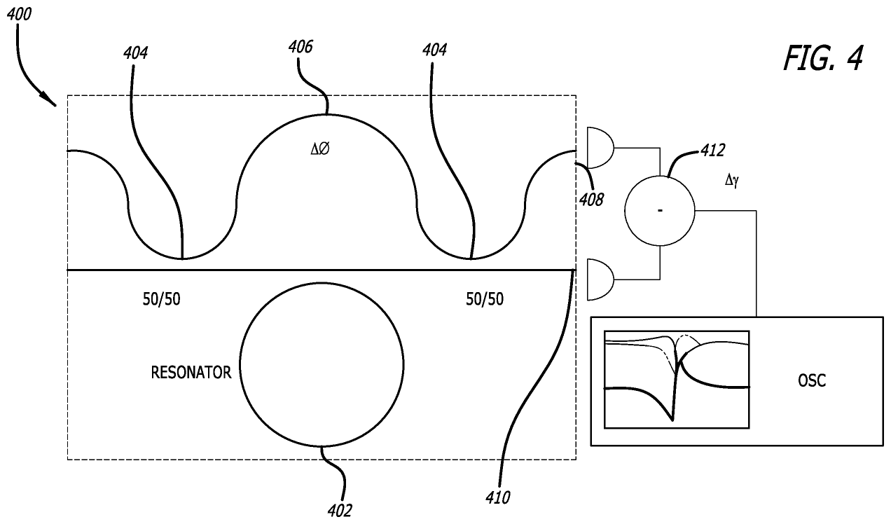

An example integrated self-delayed coil-resonator for high sensitivity optical frequency discrimination and laser linewidth narrowing is conceptually illustrated in FIG. 4. A self-delayed coil resonator 400 can include a waveguide coil resonator 402. In many embodiments, waveguide coil resonators can be 2-meter-long. The waveguide coil resonator 402 can be coupled to a waveguide Mach Zehnder interferometer (MZI). The waveguide MZI can include two directional couplers (e.g., 50/50 directional couplers) 404 and a waveguide phase delay section 406. A first port 408 and a second port 410 can be connected to a photodetector 412. The waveguide delay section 406 can be positioned between a first and second of the directional couplers. In many embodiments, a waveguide can be 6 μm by 80 nm for a TE₀ mode to have a waveguide loss below 0.5 dB/m. The waveguide can have a critical bending radius below 1 mm using an ultra-low-loss silicon nitride fabrication process. The unbalancing delay length (e.g., as corresponding to a waveguide delay section), in many embodiments, can be around ΔL=2.2 mm, corresponding to a uMZI FSR of 0.72 nm. Directional couplers can have coupling power of around κ²=50% with a 2.0 μm gap and/or 1.4 mm coupling length.

In accordance with several embodiments, a laser optical frequency is selected from Deep UV, UV, near UV, Visible, Near IR, Mid IR and IR wavelengths. In many embodiments, photonic integrated circuits can be formed of a material such as silicon nitride, tantalum pentoxide, alumina nitride, and alumina oxide.

Delay arms, waveguides, and/or resonators, in many embodiments can be configured to control optical properties. Configuration of such components can be achieved using tuning effects. Tuning effects can be electro-optic tuning effect, stress-optic tuning effect, current-injection tuning effect, and thermo-optic tuning effect.

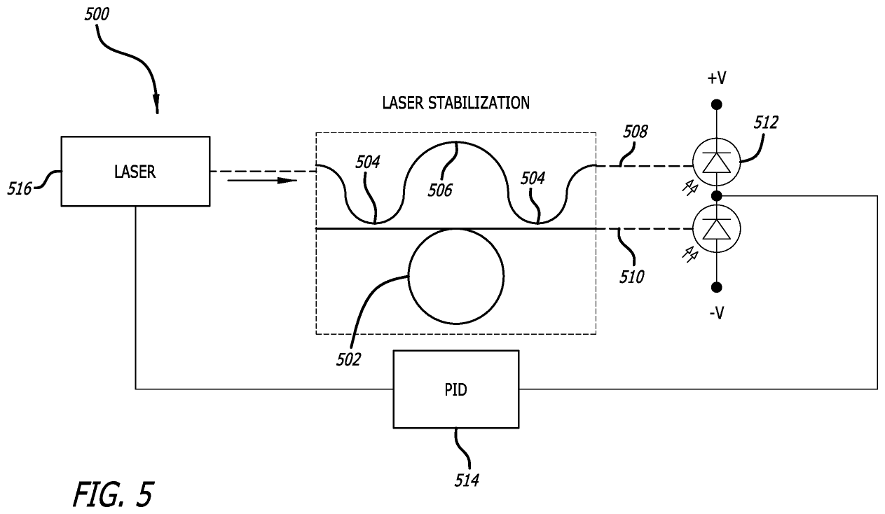

An example integrated self-delayed coil-resonator for laser linewidth narrowing is conceptually illustrated in FIG. 5. A self-delayed coil resonator laser stabilization system 500 can include a waveguide coil resonator 502. In many embodiments, waveguide coil resonators can be 2-meter-long. The waveguide coil resonator 502 can be coupled to a waveguide Mach Zehnder interferometer (MZI). The waveguide MZI can include two directional couplers (e.g., 50/50 directional couplers) 504 and a waveguide phase delay section 506. A first port 508 and a second port 510 can be connected to a detector 512. The detector 512 can be connected to a proportional-integral-derivative (PID) controller 514. The PID controller 514 can be connected to a laser 516. The laser 516 connected as an input to the waveguide MZI. The waveguide delay section 506 can be positioned between a first and second of the directional couplers.

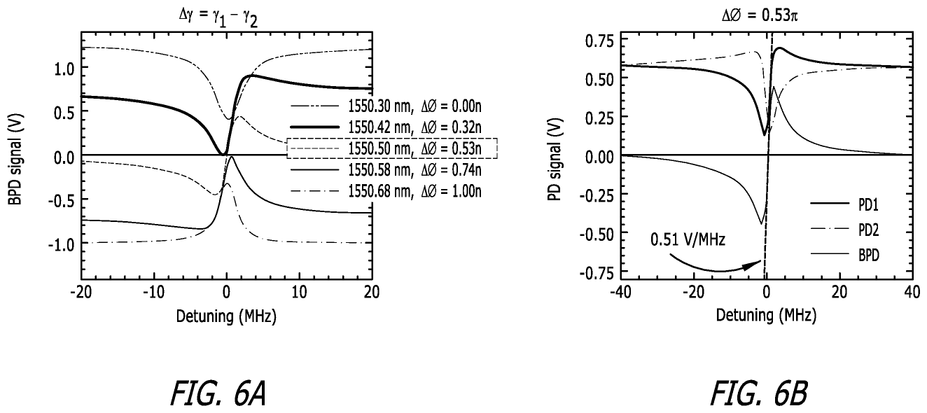

An example spectral scanning balanced detection output from an MZI with integrated self-delayed coil-resonator at different wavelengths and phases is conceptually illustrated in FIG. 6A. An example spectral scan response from both ports of a MZI with integrated self-delayed coil-resonator at 1550.50 nm and Δϕ=0.53π is conceptually illustrated in FIG. 6B.

The example spectral scan responses shown in FIG. 6A-B can be generated using a widely tunable laser (e.g., Velocity™ TLB-6700) for spectral scanning, a balanced photodetector (e.g., Thorlabs PDB470C), and/or a fiber uMZI with around a 5.87 MHz FSR for calibration of the spectral scanning.

In several embodiments, at 1550.30 nm and Δϕ=0, the loaded and intrinsic Qs of a coil resonator can be around 40 million and around 61 million respectively (e.g., as shown in FIG. 6A). In some embodiments, when the laser wavelength is changed from 1550.30 nm to 1550.68 nm, the uMZI phase section delay can changes from 0 to π, indicating the uMZI FSR is around 0.76 nm. At 1550.50 nm and Δϕ=0.53π, the two outputs are symmetric to each other and the balanced detection of the two yields a PDH-error-signal-like response with a zero-DC quadrature point (e.g., as shown in FIG. 6B), where the frequency discrimination slope is measured to be 0.51 V/MHz in accordance with embodiments of the invention.

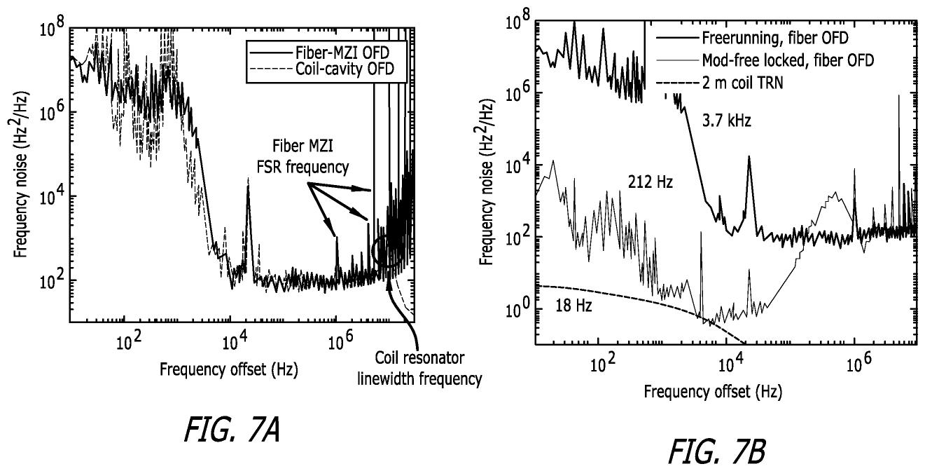

An example of laser noise measurements using modulation-free cavity OFD compared to fiber uMZI OFD is conceptually illustrated in FIG. 7A. An example of laser stabilization data from using a modulation-free self-delayed coil resonator is conceptually illustrated in FIG. 7B. An integrated circuit OFD, in accordance with many embodiments, can be compared to a 1-MHz-FSR fiber uMZI OFD. This comparison can include first measuring a free running laser (e.g., Velocity™ TLB-6700) and locking the free running laser to the self-delayed coil resonator OFD, without modulation, using direct feedback and balanced detection. In several embodiments, an integrated circuit cavity OFD and/or laser stabilization can provide over 4 orders of magnitude noise reduction and integral linewidth narrowing to 212 Hz, representing a 17× reduction from the free-running laser linewidth of around 3.7 kHz.

In numerous embodiments, an integrated high-sensitivity and low-noise on-chip OFD and frequency reference can include a self-delayed coil resonator. The self-delayed coil resonator can around 2 meters in length. The self-delayed coil resonator can be fabricated in the ultra-low-loss Si₃N₄ platform. In several embodiments a integrated coil resonator OFD can have a 61 million intrinsic Q, 96.9 MHz FSR and/or 0.51 V/MHz OFD slope.

In several embodiment, modulation free linewidth narrowing can reduce frequency noise by around 4 orders of magnitude and/or can reduce an integral linewidth to around 212 Hz (e.g., a factor of around 17× improvement over a free running linewidth).

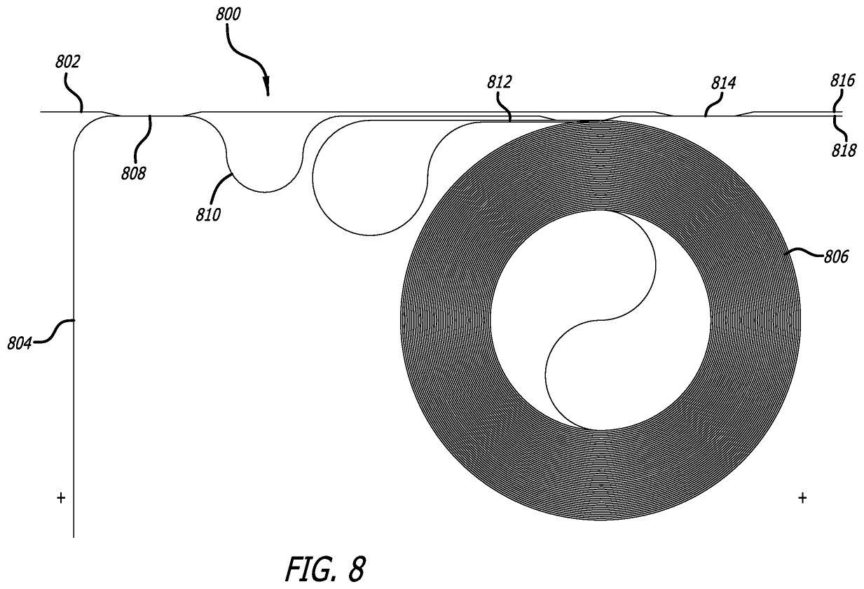

An example self-delayed coil resonator suitable for use in OFD and laser stabilization is conceptually illustrated in FIG. 8. The self-delayed coil resonator 800 can include a first waveguide 802, a second waveguide 804, and a coil resonator 806. The first and second waveguides 802, 804 can be coupled by a coupler (e.g., a 50/50 splitter and recombiner) 808. After waveguided light passes the coupler 808, it can pass through a delay arm 810. The delay arm 810 can form part of the second waveguide 804. At a position downstream of the delay arm 810, the waveguided light in the second waveguide 804 can be coupled by a second coupler 812 into the coil resonator 806. At a position after the coupler 812 along the second waveguide 804, the first and second waveguides 802, 804 can be coupled by a third coupler 814. The first waveguide 802 can have a first port 816. The second waveguide 804 can have a second port 818. In many embodiments, a coupler can be a 50-50 coupler and/or recombiner. Couplers can, in some embodiments, include an MZI gap of around 20 μm and/or have a length of around 1.4 mm. A coupler for coupling into a coil resonator, can in accordance with embodiments of the invention, have a gap of around 2.5 μm, and/or have a length of around 1.0 mm. In many embodiments, a self-delayed resonator can be used in an optical frequency discriminator (OFD) and/or a modulation-free PDH lock. In accordance with embodiments of the invention, light can be received into a first port. The light received to the first port can be coupled from a first waveguide to a second waveguide. After first coupling, the light can also be coupled into a coil resonator. In accordance with many embodiments light can sequentially travel first through a first coupler, be coupled into a coil resonator, and third travel through a second couple.

In many embodiments, a first output port of the first waveguide and a second output port of the second waveguide can be connected to a photodetector such that an optical signal can be used for optical frequency discrimination, laser stabilization and/or laser linewidth narrowing.

While specific methods and/or systems for integrated self-delayed coil-resonator are described above, any of a variety of methods and/or systems can be utilized as a integrated self-delayed coil-resonator as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference to a integrated self-delayed coil-resonator, the techniques disclosed herein may be used in any type of integrated optical system. The techniques disclosed herein may be used within any of the integrated optical systems, laser stabilization systems, linewidth narrowing systems, optical frequency discriminator systems, and/or other components and/or systems as described herein.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A photonic integrated circuit forming part of a Mach Zehnder interferometer, the photonic integrated circuit comprising:
a first waveguide with an optical input at a first port and comprising a waveguide delay arm;
a second waveguide;
a first coupler that optically couples the first waveguide to the second waveguide at a first position; and
a second coupler that optically couples the first waveguide to the second waveguide at a second position, the second position different from the first position.

2. The photonic integrated circuit of claim 1, wherein light received to the first port sequentially passes first through the first coupler, second through the waveguide delay arm, and third through the second coupler.

3. The photonic integrated circuit of claim 1, wherein the waveguide delay arm is around 2 meters long.

4. The photonic integrated circuit of claim 1, wherein the waveguide delay arm is positioned between the first coupler and the second coupler along a beamline.

5. The photonic integrated circuit of claim 1, wherein a first output port of the first waveguide and a second output port of the second waveguide is connected to a photodetector such that an optical signal can be used for optical frequency discrimination.

6. The photonic integrated circuit of claim 1, wherein a first output port of the first waveguide and a second output port of the second waveguide is connected to a detector such that an optical signal can be used to generate a control input for a laser.

7. The photonic integrated circuit of claim 1, wherein the first coupler has a gap of around 2 μm and a length of around 1.4 mm.

8. The photonic integrated circuit of claim 1, wherein a first output port of the first waveguide and a second output port of the second waveguide are used for laser stabilization.

9. The photonic integrated circuit of claim 1, wherein a laser optical frequency is selected from a list consisting of Deep UV, UV, near UV, Visible, Near IR, Mid IR and IR wavelengths.

10. The photonic integrated circuit of claim 1, wherein the photonic integrated circuit is formed of a material, the material selected from a list consisting of silicon nitride, tantalum pentoxide, alumina nitride, and alumina oxide.

11. A photonic integrated circuit forming part of a Mach Zehnder interferometer, the photonic integrated circuit comprising:
a resonator;
a first waveguide comprising an optical input at a first port and a delay arm;
a second waveguide, the second waveguide coupled to the resonator at a first position;
a first coupler that optically couples the first waveguide to the second waveguide at a second position; and
a second coupler that optically couples the first waveguide to the second waveguide at a third position,
wherein the waveguide delay arm is positioned between the first coupler and the second coupler.

12. The photonic integrated circuit of claim 11, wherein optical properties of the delay arm can be configured by a tuning effect, the tuning effect selected from a list consisting of electro-optic tuning effect, stress-optic tuning effect, current-injection tuning effect, and thermo-optic tuning effect.

13. The photonic integrated circuit of claim 11, wherein the waveguide resonator is a coil resonator.

14. The photonic integrated circuit of claim 11, wherein an output from an output port is connected to a photodetector such that an optical signal can be used for optical frequency discrimination.

15. The photonic integrated circuit of claim 11, wherein an output from an output port is connected to a detector such that an optical signal can be used to generate a control input for a feedback loop to lock a laser.

16. The photonic integrated circuit of claim 11, wherein the first coupler has a gap of around 1 μm and a length of around 1.4 mm.

17. The photonic integrated circuit of claim 11, wherein a first output port of the first waveguide and a second output port of the second waveguide are used for laser stabilization.

18. The photonic integrated circuit of claim 11, wherein a laser optical frequency is selected from a list consisting of Deep UV, UV, near UV, Visible, Near IR, Mid IR and IR wavelengths.

19. The photonic integrated circuit of claim 11, wherein the photonic integrated circuit is formed of a material, the material selected from a list consisting of silicon nitride, tantalum pentoxide, alumina nitride, and alumina oxide.

20. A photonic integrated circuit forming part of a Mach Zehnder interferometer, the photonic integrated circuit comprising:
a first waveguide with an optical input at a first port and a delay arm;
a second waveguide;
a first coupler that optically couples the first waveguide to the second waveguide at a first position;
a waveguide coil resonator; and
a second coupler that optically couples the first waveguide to the second waveguide at a second position, the second position different from the first position.
